(19) United States
(12) Patent Application Publication
(10) Pub. No.: US 2022/0025919 A1
(43) Pub. Date: Jan. 27, 2022

(54) WINGED FASTENER, BUILDING CONSTRUCTION UTILIZING A WINGED FASTENER AND METHOD OF USE OF A WINGED FASTENER

(71) Applicant: Advanced Architectural Products, LLC, Allegan, MI (US)

(72) Inventor: G. Matt Krause, Allegan, MI (US)

(21) Appl. No.: 16/934,702

(22) Filed: Jul. 21, 2020

(51) Int. Cl. F16B 35/06; E04B 1/41

(52) U.S. Cl. CPC F16B 35/06; E04B 1/40

(57) ABSTRACT

A winged fastener includes a head, a shaft, and a plurality of wings, and other configurations with a single wing. The head disposed at a first end of the winged fastener. The shaft is coupled to the head and extends to a second end of the winged fastener, the shaft including a threaded portion that is disposed between the head and the second end of the winged fastener. The plurality of wings coupled to the shaft and disposed between the threaded portion and the second end of the winged fastener, a width of the plurality of wings being greater than a width of the threaded portion. A building construction is likewise shown, as is a method of using a winged fastener to couple portions of a building construction.

### CROSS-REFERENCE TO RELATED APPLICATION

N/A

### BACKGROUND OF THE DISCLOSURE

### 1. Field of the Disclosure

The disclosure relates in general to a fastener, and more particularly, to a winged fastener. The disclosure is further directed to a building construction utilizing a winged fastener, as well as a method of use of a winged fastener to couple components of a building construction together.

### 2. Background Art

Fasteners have a multitude of uses, from assembly of appliances to building construction. As such, fasteners come in a variety of sizes and configurations. Some fasteners are tapered, forming a screw shaft, while other fasteners have a constant diameter shaft, forming a bolt. Fasteners typically have some type of head that allows the fastener to receive a rotational force to screw the fastener into a material or a nut, depending upon the type of fastener being used.

In some applications, dissimilar materials are attached together. Such materials may have different rates of expansion and contraction. In such conditions, over time, the relative movement between the dissimilar materials may result in the loss of adequate fastening and/or joining between the dissimilar materials. In other configurations, the fastener may become compromised due to the failure of allowing proper and desirable relative movement between components.

### SUMMARY OF THE DISCLOSURE

The disclosure is directed to a winged fastener that includes a head, a shaft, and a plurality of wings. The head disposed at a first end of the winged fastener. The shaft is coupled to the head and extends to a second end of the winged fastener, the shaft including a threaded portion that is disposed between the head and the second end of the winged fastener. The plurality of wings is coupled to the shaft and disposed between the threaded portion and the second end of the winged fastener, with a width of the plurality of wings being greater than a width of the threaded portion. It is contemplated that a single wing may be utilized with a number of different configurations.

In at least one embodiment, the winged fastener includes a self-tapping end disposed at the second end of the winged fastener.

In at least one embodiment, the plurality of wings are coupled substantially to opposite sides of the shaft.

In at least one embodiment, the head is one of a hex head and a round head including a screw drive.

In at least one embodiment, the hex head includes a screw drive.

In at least one embodiment, the screw drive is a Phillips drive.

In at least one embodiment, the plurality of wings include a tapered edge proximate to the threaded portion.

In at least one embodiment, the plurality of wings are disposed proximate to the threaded portion.

In at least one embodiment, the head has an approximate width of 0.375 inches, the shaft has an approximate length of 1.250 inches and an approximate width of 0.250 inches.

In at least one embodiment, the plurality of wings have an approximate width of 0.063 inches.

In at least one embodiment, the head includes a washered portion integrated with the head.

In at least one embodiment, the winged fastener further comprises a washer distinct from the winged fastener and loosely coupled to the shaft, such that the washer can move freely on the shaft.

In another aspect of the disclosure, the disclosure is directed to a building construction having a polymer bracket, a first wall support, a substrate, a cladding and a winged fastener. The polymer bracket has a central body, a first wall and a second wall. The first wall extends from a distal end of the central body and the second wall extending from a proximal end of the central body. The first wall support is positioned on an inner surface of the first wall. The substrate has an outer surface, with the second wall of the polymer bracket being coupled thereto. The cladding is positioned over an outside wall of the first wall of the polymer, thereby sandwiching the first wall of the polymer bracket between the cladding and the first wall support. The winged fastener extends through an opening in each of the cladding, the first wall and the first wall support. The opening in the first wall and the first wall support was formed by the winged fastener, and the opening in the first wall is larger than that of the first wall support, with the fastener threaded into the opening of the first wall support.

In some configurations, the winged fastener is spaced apart from the first wall defining the opening.

In some configurations, the opening in the cladding is formed by the winged fastener, and the opening in the cladding is larger than that of the first wall support.

In some configurations, the winged fastener includes a head, and wherein the head remains outside of the opening of the first wall of the polymer bracket.

In some configurations, the head remains outside of the opening of the cladding.

In another aspect of the disclosure, the disclosure is directed to a method of forming a building construction comprising the steps of: providing a polymer bracket having a central body, a first wall and a second wall; positioning a first wall support on an inside of the first wall; positioning a cladding on an outside of the first wall, to, in turn, sandwich the polymer bracket between the cladding and the first wall support; providing a winged fastener, the winged fastener having a head, a threaded portion, at least one wing extending from a shaft thereof and a self drilling portion opposite the head; directing the winged fastener through an opening of the cladding; directing the winged fastener into contact with the first wall of the polymer bracket; forming an opening in the first wall of the polymer bracket with the winged fastener; enlarging the opening with the at least one wing of the winged fastener; directing the winged fastener into the first wall support; forming an opening in the first wall support; breaking off the at least one wing by the wall support, as the at least one wing comes into contact with the first wall support so that the opening in the first wall support is smaller than that of the first wall; and threading the threaded portion of the winged fastener into the first wall support.

In some configurations, the method includes the step of forming an opening in the cladding by the winged fastener, prior to the step of directing the winged fastener through an opening of the cladding.

### BRIEF DESCRIPTION OF THE DRAWINGS

The disclosure will now be described with reference to the drawings wherein:

FIG. 1 illustrates a winged fastener, in accordance with at least one embodiment disclosed herein;

FIG. 2 illustrates a first end view of the winged fastener shown in FIG. 1, in accordance with at least one embodiment disclosed herein;

FIGS. 4a and 4b illustrate the winged fastener shown in FIG. 1 as the winged fastener is being screwed into first and second materials, in accordance with at least one embodiment disclosed herein;

FIG. 5 illustrates another winged fastener, in accordance with at least one embodiment disclosed herein;

FIG. 6 illustrates a cross-sectional configuration of an environment in which the winged fastener can be utilized, wherein the winged fastener is utilized to couple cladding to a polymer bracket having a metal support or brace, and also utilized to couple the polymer bracket having such a metal support or brace member to an underlying substrate, in accordance with at least one embodiment disclosed herein; and

FIG. 7 illustrates a partial cross-sectional configuration of an environment in which the winged fastener can be utilized to couple portions of a building construction together, in accordance with at least one embodiment disclosed herein.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

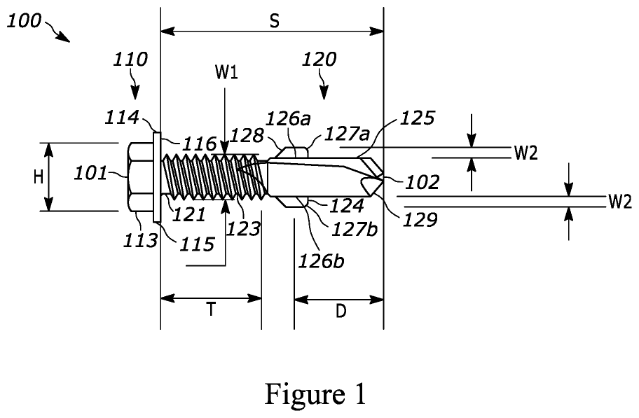

Referring now to the drawings and in particular to FIG. 1, a fastener is disclosed, such as a winged fastener 100. The winged fastener 100 includes a first end 101 and a second end 102 on an opposite end of the winged fastener than the first end 101. The winged fastener 100 can be made from steel, aluminum, a composite, an alloy of steel and/or aluminum, or any other material that provides strength needed to allow the winged fastener 100 to be screwed into a desired material. The winged fastener 100 is of the type of fastener that is typically screwed into a construction member, such that the winged fastener 100 is used to hold a plastic composite member against the construction member.

The winged fastener 100 includes a head, such as a hexagonal (hex) head 110 disposed at the first end 101 and a shaft 120 that is coupled to the hex head 110 and extends to the second end 102. In at least one embodiment, the hex head 110 has an approximate (+−10%) width W, e.g., 0.375 inches and the shaft 120 has an approximate (+−10%) length S, e.g., 1.250 inches. The hex head 110 and a shaft 120 can be integrated together during manufacture such that the winged fastener 100 is one component. Alternatively, the hex head 110 can be coupled to the shaft 120 after each is manufactured individually, either via an industrial adhesive or some type of welding. Irrespective of how the hex head 110 and the shaft 120 are coupled, the shaft 120 is rotated when a rotational force is applied to the hex head 110, such that the hex head 110 and the shaft 120 rotate as one unit during use.

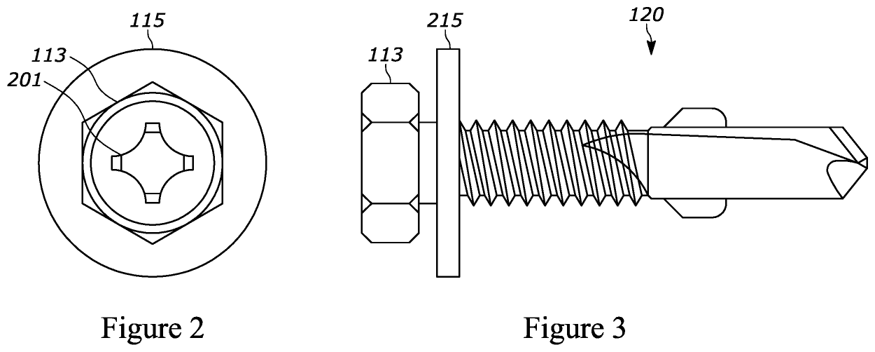

The hex head 110 includes a hexagonal portion 113 disposed at the first end 101 of the hex head 110 and, in at least one embodiment, a washered portion 115 disposed between the hexagonal portion 113 and the shaft 120. The washered portion 115 extends a width of the hex head 100 to increase a contact surface of the hex head 110 without adding additional material to the winged fasterner 100, as shown. The hexagonal portion 113 is configured with a hexagonal perimeter such that a socket type driver can be used to drive the winded fastener into a desired material. In at least one embodiment, the hexagonal portion 113 can further include a screw drive 201 (FIG. 2), such as a slotted drive, a Phillips drive (shown), a torx drive, spline drive, a Robertson drive, an Allen drive, or any other drive that can be used to screw the winged fastener 100 into a desired material. The washered portion 115 can be integrated with the hexagonal portion 113, as shown in FIG. 1, or, alternatively, can be a distinct washer 215 (FIG. 3) that is loosely coupled onto the shaft 120, such that the washer 215 can move freely on the shaft 120.

The shaft 120 can include a threaded portion 123 disposed between the hex head 110 and the second end 102. The threaded portion 123 has an approximate (+−10%) length of T, e.g., 0.563 inches, and an approximate (+−10%) width W1, e.g., 0.250 inches. In at least one embodiment, the shaft 120 can further include a shank portion 121 that is disposed between the hex head 110 and the threaded portion 123, the shank portion 120 lacking threads and having a substantially smooth surface. In at least one embodiment, the shaft 120 can include a sheet metal end or self-tapping end 129 disposed at the second end 102 of the type that drills its own hole as it screws into a desired material, making the winged fastener 100 easier to drill into a hard material, such as a metal.

The winged fastener 100 further includes wings, such as wings 127a/127b. The wings 127a/127b are coupled substantially (+−5 degrees) to opposite sides of the shaft 120 between the threaded portion 123 and the second end 102 of the winged fastener 100, at detach points 126a/126b, respectively, where the wings 127a/127b detach from the shaft 120, as shown. Although two wings 127a/127b are shown, the winged fastener 100 can include more wings without departing from the scope of the disclosed winged fastener 100, and it is contemplated that a single wing may be utilized. For example, the winged fastener 100 can include three (3) wings spaced 120 degrees apart coupled to the shaft 120. In the example shown, the wings 127a/127b are disposed proximate to the threaded portion 123 and include a tapered edge 128 proximate to the threaded portion 123 and a perpendicular edge 124 (perpendicular to the shaft 120) on an opposite end thereof. In other embodiments, the wings 127a/127b can be disposed away from the threaded portion 123 nearer the second end 102. Additionally, the wings can be of different shape and position along the length of the fastener, and, may be spaced apart from each other. Additionally, the winged fasteners may be disposed other than uniformly radially spaced apart about the outer surface of the fastener. Advantageously, symmetrical configurations facilitate weight balance and rotational stability, however, other variations are contemplated.

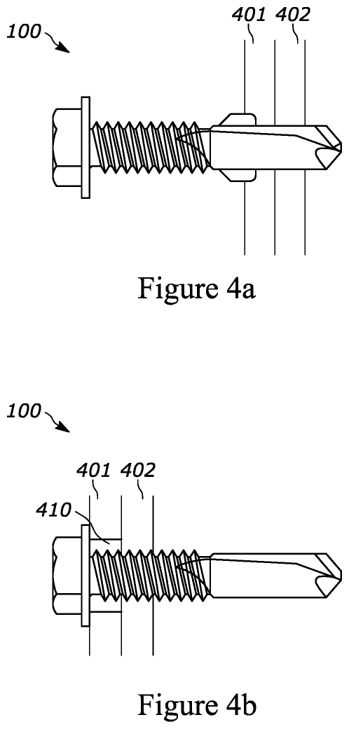

As shown, the wings 127a/127b are disposed an approximate (+−10%) distance D, e.g., 0.500 inches, from second end 102 and extend an approximate (+−10%) width W2, e.g., 0.063 inches, from an outside edge 125 of the shaft 120. The wings 127a/127b include enough material strength that the wings 127a/127b create a hole 410 larger than the width W1 of the threaded portion 123 as the winged fastener 100 is being screwed into a first material 401 (FIG. 4a), such as the plastic composite. Plastic composites, such as those used in construction materials, thermally expand and contract. Thus, the winged fastener 100 disclosed herein, via the wings 127a/127b, creates an oversize hole 410 (FIG. 4a) that allows for thermal movement of the first material 401 relative to the winged fastener 100 and the second material 402 when the first material 401 expands and contracts due to thermal expansion and contraction. The hex head 110 includes a bottom surface 116, proximate to the shaft 123, that extends between the shaft and an outer edge 114 of the hex head 110 that is planar and substantially perpendicular (+−5%) to the shaft 123 along the length of the bottom surface 116 to allow for the thermal movement.

Then, as the winged fastener 100 is further screwed into a second material 402 (FIGS. 4a and 4b), such as a construction member, e.g., a metal construction member, the wings 127a/127b break off of the shaft 123 at the at detach points 126a/126b, respectively. The threaded portion 123 screws into the first material 410 member to hold the first material 401 against the second material 402, while allowing thermal movement of the first material 401 relative to the second material 402 and the winged fastener 100, as shown in FIG. 4b. The wings 127a/127b can be made of more or less material depending upon the strength of the material used to construct the winged fastener 100, and the types of the first and second materials 401/402 that the winged fastener 100 are to be used with, such that the wings 127a/127b are able to break off of the shaft 123 when the winged fastener 100 enters the second material 402.

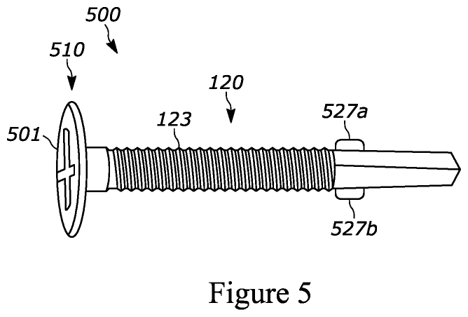

Now with reference to FIG. 5, another winged fastener 500 is disclosed. Instead of including the hex head 110, as discussed above, the winged fastener 500 includes a round head 510. The round head 510 includes a screw drive 501, such as a slotted drive, a Phillips drive (shown), a torx drive, spline drive, a Robertson drive, an Allen drive, or any other drive that can be used to screw the winged fastener 500 into a desired material. The winged fastener 500 also includes alternate wings 527a/527b that instead of using the tapered edge 128 discussed above, use a perpendicular edge 524 (perpendicular to the shaft 120) proximate to the threaded portion 123. As can be seen, the winged fasteners 100/500 can be made in any length needed for a particular application, with the winged fastener 100 shown as having a shorter threaded portion 123 than the winged fastener 500.

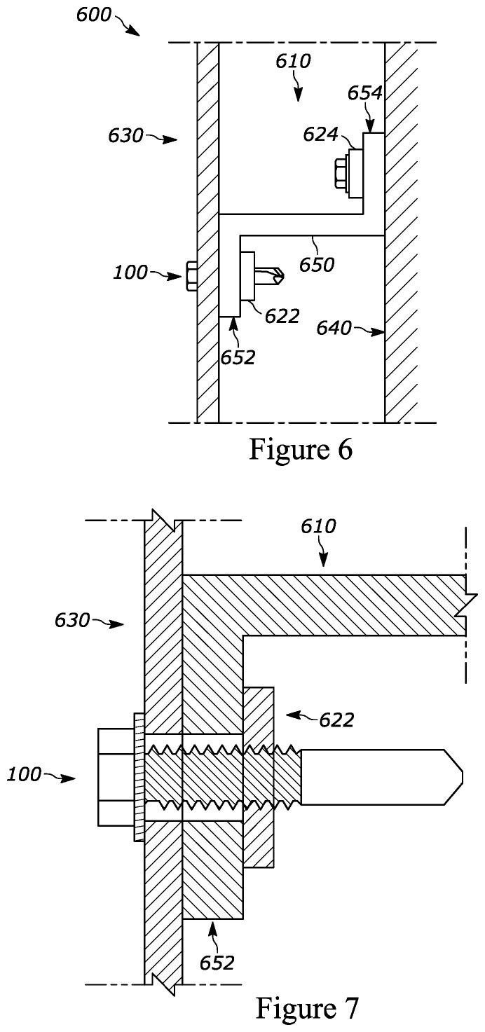

With reference to FIGS. 6 and 7, a building construction is shown at 600. The building construction utilizes a polymer based bracket 610, having one or more support members 622, 624, cladding 630 and substrate 640. The polymer based bracket 610 may comprises member that is formed from a plurality of reinforcing fibers embedded within a resin matrix. The reinforcing fibers may comprise any number of different fibers in tows, fabrics, woven configurations or the like, and may comprise glass, carbon, kevlar, among other types of fibers. The resin matrix may comprise a thermoset resin, although other resins, such as thermoplastic resins are likewise contemplated, depending on the application. One common manner in which such a bracket can be formed is through a pultrusion process, while cast processes, and additive processes, among others are likewise contemplated.

The polymer based bracket 610 may include central body 650, first wall 652 and second wall 654. Generally, the first wall 652 and the second wall 654 are on opposite ends of the central body 650 with the first wall being at a distal end of the central body and the second wall being at a proximal end of the central body. The first and second walls are generally parallel to each other, although variations are contemplated. The central body is one of oblique and perpendicular to at least one if not both of the first wall and the second wall. In the configuration shown, the first wall and the second wall extend on opposite sides of the central body, while it is contemplated that such walls may extend, individually or collectively, on both sides of the central body.

The first wall support 622 is positioned on an inner side of the first wall opposite the cladding 630. The first wall support 622 preferably comprises a metal (i.e., a metal member, including any alloys thereof). One such metal may comprise a steel material, while others are contemplated. In the configuration shown, the first wall support is showing as being substantially planar and positioned on top of the inner side of the first wall (where it may be adhered, mechanically coupled, collectively molded, among other solutions). In other configurations, the metal may be coupled mechanically to the first wall on the inner side thereof, and/or partially embedded in the first wall.

Similar to the first wall support, the second wall support 624 is positioned on the outer side of the second wall support on the opposite side of substrate 640. The second wall support 624 may be formed from the same material or a different material than that of the first support wall. Additionally, the attachment of the second wall support may be the same as or different than that of the first wall support. It will be understood that in some configurations, only one wall support may be present, that is, either one of the first wall support and the second wall support.

It will further be understood that the first and second wall supports may be continuous or may comprise discrete and separate segments that are attached to or positioned to overly the respective first wall and second wall of the polymer bracket. For example, a length of a polymer bracket may be eight feet (again, just exemplary and not to be deemed limiting) and the wall supports may also be eight feet and continuous along the length thereof. In other configurations, the wall supports may comprise discrete segments, that may be, for example, only inches in length or which may be feet in length. There may be symmetry between the first wall support and the second wall support, or they may be staggered relative to each other. Furthermore, where the walls extend on either side of the central body, a wall support may be on both sides or only one side of the central body, that is, overlying the respective wall on one or both sides of the central body.

While not limited thereto, some such polymer brackets and wall supports, for purposes of illustration, are shown in U.S. Pat. No. 8,833,025 issued to Krause; U.S. Pat. No. 9,151,052 issued to Krause; U.S. application Ser. No. 16/912,575 of Krause; U.S. application Ser. No. 16/879,754 of Krause, the entire specification of each of which is hereby incorporated by reference in their entireties.

The cladding 630 may comprise any number of different structures, such as sheet metal, fiberboard, a baseboard or material for the application of stucco, stone or other substrates, or, other sheet material, for example. The particular material of the cladding 630 may be widely varied with the understanding that it is preferred that the material be fastened to the first wall utilizing a fastener, and the winged fastener of the present disclosure comprises a suitable fastener.

The substrate 630 may comprise any number of different structures, including, for example, masonry, fiberboard, wood (such as particleboard, underlayment, plywood, or the like), and wood or metal studs, among other constructions and combinations of constructions.

In such an environment, the winged fastener is configured to remain intact through the cladding and the first wall of the polymer bracket. When the winged fastener reaches the first wall support, the material is of greater strength than the winged fastener, and the wings break off as the fastener is directed through the first wall support.

As a result, a larger opening is formed in each of the cladding and the polymer bracket which allows the cladding and the polymer bracket to move relative to each other through natural expansion and contraction, and also relative to the first wall support. It will be understood that with either the washer or the flat inner surface of the winged fastener, and due to the larger opening (caused by the winged portions) in each of the cladding and the first wall of the polymer bracket a range of relative movement can occur without applying an undesirable force against the walls of the opening in each of the cladding and the first wall.

In some configurations, it may be necessary to pre-drill the cladding, wherein the cladding is of sufficient strength to break with winged fastener. In still other configurations, the cladding can be designed so that the force required to break the wings of the winged fastener are greater than the force required to be directed therethrough.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A winged fastener, comprising:
a head disposed at a first end of the winged fastener;
a shaft that is coupled to the head and extends to a second end of the winged fastener, the shaft including a threaded portion that is disposed between the head and the second end of the winged fastener; and
a plurality of wings coupled to the shaft and disposed between the threaded portion and the second end of the winged fastener, a width of the plurality of wings being greater than a width of the threaded portion.

2. The winged fastener according to claim 1, wherein the winged fastener includes a self-tapping end disposed at the second end of the winged fastener.

3. The winged fastener according to claim 1, wherein the plurality of wings are coupled substantially to opposite sides of the shaft.

4. The winged fastener according to claim 1, wherein the head is one of a hex head and a round head including a screw drive.

5. The winged fastener according to claim 4, wherein the hex head includes a screw drive.

6. The winged fastener according to claim 1, wherein the screw drive is a Phillips drive.

7. The winged fastener according to claim 1, wherein the plurality of wings include a tapered edge proximate to the threaded portion.

8. The winged fastener according to claim 1, wherein the plurality of wings are disposed proximate to the threaded portion.

9. The winged fastener according to claim 1, wherein the head has an approximate width of 0.375 inches, the shaft has an approximate length of 1.250 inches and an approximate width of 0.250 inches.

10. The winged fastener according to claim 1, wherein the plurality of wings have an approximate width of 0.063 inches.

11. The winged fastener according to claim 1, wherein the head includes a washered portion integrated with the head.

12. The winged fastener according to claim 1, further comprising a washer distinct from the winged fastener and loosely coupled to the shaft, such that the washer can move freely on the shaft.

13. A building construction comprising:
a polymer bracket having a central body, a first wall and a second wall, the first wall extending from a distal end of the central body and the second wall extending from a proximal end of the central body;
a first wall support positioned on an inner surface of the first wall;
a substrate having an outer surface, with the second wall of the polymer bracket being coupled thereto;
a cladding positioned over an outside wall of the first wall of the polymer, thereby sandwiching the first wall of the polymer bracket between the cladding and the first wall support;
a winged fastener extending through an opening in each of the cladding, the first wall and the first wall support, wherein the opening in the first wall and the first wall support was formed by the winged fastener, and the opening in the first wall is larger than that of the first wall support, with the fastener threaded into the opening of the first wall support.

14. The building construction of claim 13 wherein the winged fastener is spaced apart from the first wall defining the opening.

15. The building construction of claim 13 wherein the opening in the cladding is formed by the winged fastener, and the opening in the cladding is larger than that of the first wall support.

16. The building construction of claim 13 wherein the winged fastener includes a head, and wherein the head remains outside of the opening of the first wall of the polymer bracket.

17. The building construction of claim 16 wherein the head remains outside of the opening of the cladding.

18. A method of forming a building construction comprising the steps of:
providing a polymer bracket having a central body, a first wall and a second wall;
positioning a first wall support on an inside of the first wall;
positioning a cladding on an outside of the first wall, to, in turn, sandwich the polymer bracket between the cladding and the first wall support;
providing a winged fastener, the winged fastener having a head, a threaded portion, at least one wing extending from a shaft thereof and a self drilling portion opposite the head;
directing the winged fastener through an opening of the cladding;
directing the winged fastener into contact with the first wall of the polymer bracket;
forming an opening in the first wall of the polymer bracket with the winged fastener;
enlarging the opening with the at least one wing of the winged fastener;
directing the winged fastener into the first wall support;
forming an opening in the first wall support;
breaking off the at least one wing by the wall support, as the at least one wing comes into contact with the first wall support so that the opening in the first wall support is smaller than that of the first wall; and
threading the threaded portion of the winged fastener into the first wall support.

19. The method of claim 18 further comprising the step of forming an opening in the cladding by the winged fastener, prior to the step of directing the winged fastener through an opening of the cladding.
